(19) United States
(12) Patent Application Publication
(10) Pub. No.: US 2004/0174159 A1
(43) Pub. Date: Sep. 9, 2004

(54) Securement feature for rotary position sensor

(76) Inventor: Claudia Ramirez, El Paso, TX (US)

Correspondence Address: MARGARET A. DOBROWITSKY, DELPHI TECHNOLOGIES, INC., Legal Staff, Mail Code: 480-410-202, P.O. Box 5052, Troy, MI, 48007-5052, US

(21) Appl. No.: 10/379,787

(22) Filed: Mar. 5, 2003

(51) Int. Cl. G01B 7/30

(52) U.S. Cl. 324/207.13; 324/207.25

(57) ABSTRACT

A securement feature for axially aligning a rotor and a stator of a non-contacting rotary position sensor having over all sensor containment. The stator has a cylindrical hub axially centered on the rotation axis of the rotor. A sensor cavity is located in the hub whereat a magnetosensitive device is located. The rotor has a cylindrical socket and a pair of magnets proximal the socket which are transversely aligned with the magnetosensitive device. The hub is received by the socket, wherein the hub has a distal end portion which protrudes beyond an end face of the rotor. The distal end portion has a slot oriented transverse to the rotation axis. A clip is received by the slot and thereby interferingly abuts the end face so as to hold the stator in alignment with the rotor, and as a direct consequence, aligns the magnets with respect to the magnetosensitive device.

### TECHNICAL FIELD

The present invention relates to rotary position sensors which sense position based upon a measurement of relative rotation between a stator and a rotor, and more particularly to a feature which secures the placement of the rotor relative to the stator.

### BACKGROUND OF THE INVENTION

Rotary position sensors are used in a number of applications in which there is relative movement between first and second components. A stator is connected to the first component, and a rotor is connected to a second component, wherein as the second component moves with respect to the first component, the rotor rotates with respect to the stator.

Rotary position sensors utilize a magnetic field and a magnetosensitive device, such as a Hall effect device or a magnetoresistive device located within the magnetic field. To detect rotational movement as between the rotor and the stator, the magnetic field is oriented transverse in relation to the axis of rotation of the rotor. The magnetosensitive device is associated with the rotor or the stator (usually the stator), and the magnets are associated with the other of the rotor and stator (usually the rotor). As the rotor rotates relative to the stator, the magnetosensitive device is caused to change its angular position relative to the magnetic field direction, resulting in a change of output signal from the magnetosensitive device responsive to its angle with respect to the magnetic field direction. This change in signal is indicative of the angular position as between the rotor and the stator, and, therefore, the relative position as between the first and second components. An example of a rotary position sensor is described in U.S. Pat. No. 6,486,764.

A problem arises with rotary position sensors where it is desired to environmentally contain the sensor and yet have the rotary position sensor operate non-contactingly. Such an environment, for example, may be encountered if a rotary position sensor were to be used in an automotive suspension leveling system.

What remains needed in the art is a non-contacting rotary position sensor having over all sensor containment having securement as between the rotor and stator.

### SUMMARY OF THE INVENTION

The present invention is a securement feature as between a rotor and a stator of a non-contacting rotary position sensor having over all sensor containment, wherein the rotor is rotatable in relation to the stator about a rotation axis.

The stator includes a sensor cavity in which at least one magnetosensitive device is placed at the rotation axis. Sensor circuitry may optionally be included for driving the magnetosensitive device. The magnetosensitive device, as for example a Hall effect device or a magnetoresistive device, is oriented to sense a magnetic field transverse to the rotation axis. The stator further includes an electrical interface between an external circuit and the magnetosensitive device. The stator is connected to a first component by any suitable modality.

The rotor carries at least one pair of permanent magnets, wherein the poles are opposed such as to provide a uniform magnetic field therebetween, wherein the magnetic field passes transversely through the magnetosensitive device. The rotor is configured to rotatably interface with the stator in sealing relationship. The rotor further has a mechanical linkage for connecting the rotor to a second component movable relative to the first component.

A securement feature provides reliable location between the rotor and the stator, while also establishing a reliable alignment between the magnets and the magnetosensitive device. In this regard, the stator has a cylindrical hub axially centered on the rotation axis. The sensor cavity is inside the hub. Further in this regard, the rotor has a cylindrical socket lined by a bushing which receives by the hub, wherein the hub has a distal end portion which extends protrudingly beyond an end face of the rotor. The distal end portion has a slot oriented transverse to the rotation axis. A clip is trappingly received into the slot and thereby interferingly abuts the end face so as to hold the stator in alignment with the rotor.

Accordingly, it is an object of the present invention to provide a securement feature for aligning a rotor to a stator of a non-contacting rotary position sensor having over all sensor containment.

This and additional objects, features and advantages of the present invention will become clearer from the following specification of a preferred embodiment.

### BRIEF DESCRIPTION OF THE DRAWINGS

FIG. 1 is a perspective view of a rotary position sensor according to the present invention.

FIG. 2 is a partly sectional view of the rotatry position sensor of FIG. 1.

FIG. 3 is an exploded view of the rotary position sensor of FIG. 1.

### DESCRIPTION OF THE PREFERRED EMBODIMENT

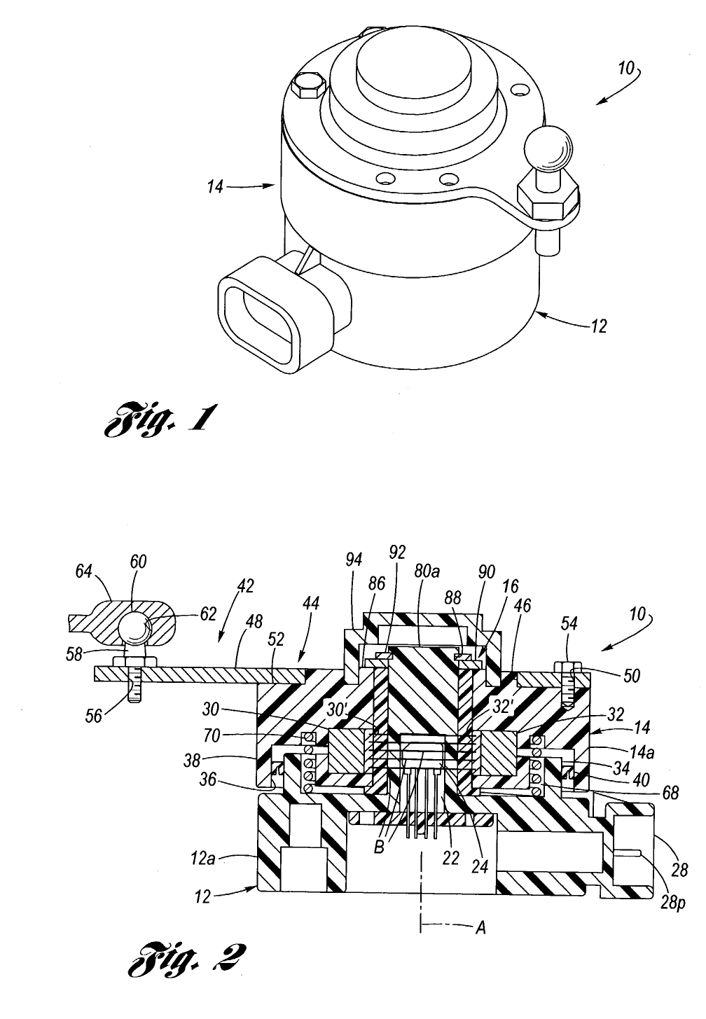

Referring now to the Drawing, FIG. 1 shows an environmentally sealed, non-contacting rotary position sensor 10. An application for the rotary position sensor 10 may be, for example, an automotive suspension leveling system in which the rotary position sensor provides a voltage output to a vehicle chassis control module, the voltage output being linearly proportional to displacement between the vehicle body and a vehicle wheel as the vehicle is driven.

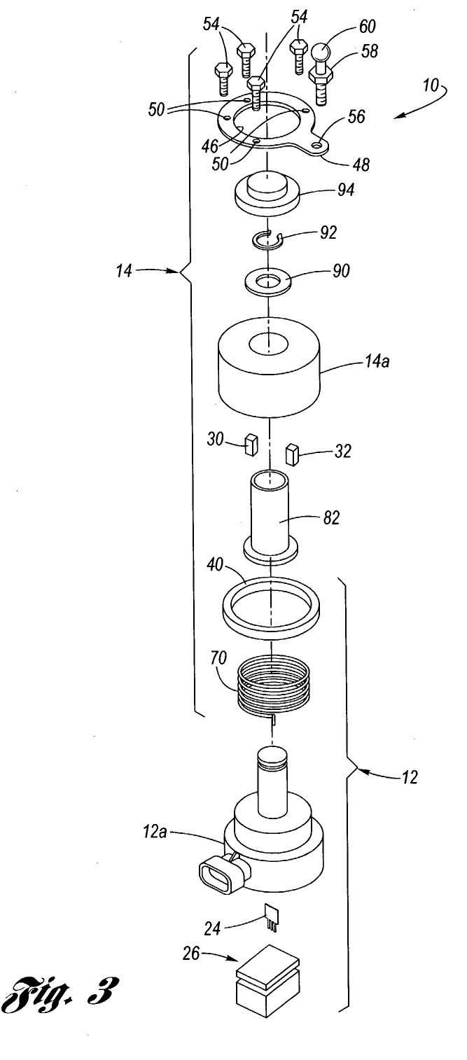

The rotary position sensor includes a stator 12, a rotor 14 rotatably interfaced with the stator via a securement feature 16 (see FIGS. 2 and 3). The stator 12 has an electrical interface 18, and the rotor has a mechanical linkage interface 20.

Now with additional reference to FIGS. 2 and 3, the structural and functional details of the rotary position sensor 10, particularly the securement feature 16 thereof, will now be presented.

The stator 12 includes a generally barrel shaped plastic stator body 12a having a sensor cavity 22 formed therein axially centered on a rotation axis A. A magnetosensitive device 24 (a Hall effect device being shown) is secured to the stator 12 inside the sensor cavity 22 such that the magnetosensitive device is located at the rotation axis A. A sensor circuit board 26 (see FIG. 3) is located within the stator for driving the magnetosensitive device 24. The magnetosensitive device is oriented to sense a magnetic field B transverse to the rotation axis A.

The stator 12 further includes an electrical receptacle 28 having pins 28p for electrically interfacing the magnetosensitive device 24 through the circuit board 26 to an external circuit. The stator 12 is connected to a first component by any suitable modality, such as for example a bracket.

The rotor 14 includes a generally barrel shaped plastic rotor body 14a which interfaces in complementary relation to the stator body 12a. Located within the rotor body 14a is a pair of permanent magnets 30, 32, wherein the pole pieces 30′, 32′ have are mutually opposed poles (ie., a north pole facing a south pole) such that the magnetic field B therebetween is transverse to the rotation axis A and uniform across the magnetosensitive device 24.

The rotor 14 is configured to rotatably interface with the stator 12 in an environmentally protective, sealing relationship. In this regard, a cylindrical peripheral surface 34 of the stator body 12a is concentrically proximal to an inner surface 36 of a cylindrical flange 38 of the rotor body 14a, wherein an annular elastomeric seal 40 is sealingly and compressably sandwiched therebetween.

The rotor 14 further has a mechanical linkage 42 for connecting the rotor to a second component (for example a vehicle wheel) movable relative to the first component (for example a vehicle body). A linkage plate 44 has a central cut-out 46, an arm 48 and a plurality of mounting holes 50. The rotor body 14a has an outer surface 52, wherein mounting bolts 54 passing respectively through the mounting holes 50 are threaded into the rotor body to thereby anchor the linkage plate to the rotor body. The arm 48 of the linkage plate 44 has a threaded hole 56. A screw 58 is threaded into the threaded hole 56, wherein the screw has a head in the shape of a ball 60. A socket 62 pivotally engages the ball 60 and provides a rigid link 64 to the second component (not shown) via a pivotal connection therewith.

An annularly shaped spring cavity 68 is provided partly in the stator 12 and partly in the rotor 14. A coil spring 70 is located in the coil cavity and is connected with the stator body 12a and the rotor body 14a. The spring 70 serves to rotationally locate the rotor body 14a relative to the stator body 12a by applying a biasing force toward a predetermined relative position whenever the rotor rotates out of this position with respect to the stator.

The securement feature 16 provides reliable location between the stator body 12a and the rotor body 14a, while also establishing a reliable alignment between the magnets 30, 32 and the magnetosensitive device 24. In this regard, the stator body 12a has a cylindrical hub 80 axially centered on the rotation axis A. The sensor cavity 22 and the magnetosensitive device 24 are located within the hub 80.

Further in this regard, the rotor body 14a has a cylindrical socket 84 which is lined by a plastic bushing 82. The socket 84, via its bushing 82, snugly receives the hub 80, yet allows easy rotative movement therebetween. The magnets 30, 32 are located in the rotor body 14a in close proximity to the socket 84 and in transverse alignment to the magnetosensitive device 24.

The hub 80 has a distal end portion 80a which protrudes in relation to an end face 86 of the rotor body 14a adjacent the socket 84. The distal end portion 80a has a slot 88 formed therein oriented transverse to the rotation axis A. A washer 90 is placed on the hub 80 and then a split washer clip 92 is pressed into the slot 88. The clip 92 is trapped in the slot and interferingly abuts the washer so as to hold the stator body 12a in alignment with the rotor body 14a. As a consequence, the magnets 30, 32 are held in perfect alignment with the magnetosensitive device by operation of the securement feature 16.

An end cap 94 is provided which sealingly interfaces with the rotor body 14a, as for example by a snap fit or an adhesive. The end cap serves to environmentally seal the securement feature 16 with respect to the rotor body 14a.

In operation of the rotary position sensor 10, the stator 12 and rotor 14 are each pre-assembled. The hub 80 is then placed into the socket 84, whereduring the elastomeric seal 40 seals the rotor with respect to the stator. The washer 90 is placed on the hub, then the clip 92 is pressed into the slot 88. Finally, the end cap 94 is affixed to the rotor body 14a. As a direct consequence of the securement feature 16 providing a fixed axial position of the hub relative to the end face of the rotor body, the pole pieces of the magnets are maintained in precise alignment with the sensing surface of the magnetosensitive device (the alignment being in a plane transverse with respect to the rotation axis A).

In the above mentioned example of operation of the rotary position sensor 10 pertaining to a suspension leveling system, as the wheel moves up and down in relation to the car body, the linkage system 42 causes the rotor to rotate relative to the stator, over a range of, for example, plus or minus 50 degrees. As the magnets rotate relative to the magnetosensitive device, the magnetosensitive device outputs a signal directly proportional to the angle of incidence of the magnetic field to the sensing surface of the magnetosensitive device. An external circuit then effects a predetermined suspension response to the signal output.

To those skilled in the art to which this invention appertains, the above described preferred embodiment may be subject to change or modification. Such change or modification can be carried out without departing from the scope of the invention, which is intended to be limited only by the scope of the appended claims.

1. A rotary position sensor, comprising:
a stator comprising:
a stator body having a hub, a sensor cavity being formed in said hub; and
at least one magnetosensitive device located in said sensor cavity;
a rotor comprising:
a rotor body having a socket formed therein; and
at least one pair of magnets having mutually opposed poles proximal to said socket; and
a securement feature comprising:
said rotor body having an end face;
said hub having an end portion protruding with respect to said end face, a slot being formed at said end portion; and
a clip trapped in said slot in interfering relationship with said end face;
wherein said rotor is rotatable with respect to said stator, and wherein said securement feature maintains said rotor body axially affixed with respect to said stator body.

2. The rotary position sensor of claim 1, further comprising a bushing located at said socket.

3. The rotary position sensor of claim 1, wherein said at least one pair of magnets and said at least one magnetosensitive device are aligned in a plane transverse to a rotation axis of the rotor relative to the stator.

4. The rotary position sensor of claim 1, further comprising a seal between said rotor body and said stator body, wherein said rotor is sealingly rotatable with respect to said stator.

5. The rotary position sensor of claim 1, further comprising a mechanical linkage connected to said rotor body, said mechanical linkage comprising:
a ball connected with said rotor body;
a socket pivotally trapped on said ball; and
a rigid link connected to said socket.

6. The rotary position sensor of claim 1, wherein said stator and rotor bodies have mutually formed therein a spring cavity; said sensor further comprising a spring located in said spring cavity and connected with said rotor and stator bodies.

7. The rotary position sensor of claim 2, wherein said at least one pair of magnets and said at least one magnetosensitive device are aligned in a plane transverse to a rotation axis of the rotor relative to the stator.

8. The rotary position sensor of claim 7, further comprising a seal between said rotor body and said stator body, wherein said rotor is sealingly rotatable with respect to said stator.

9. The rotary position sensor of claim 8, further comprising a mechanical linkage connected to said rotor body, said mechanical linkage comprising:
a ball connected with said rotor body;
a socket pivotally trapped on said ball; and
a rigid link connected to said socket.

10. The rotary position sensor of claim 9, wherein said stator and rotor bodies have mutually formed therein a spring cavity; said sensor further comprising a spring located in said spring cavity and connected with said rotor and stator bodies.

11. A rotary position sensor, comprising:
a stator comprising:
a stator body having a hub, a sensor cavity being formed in said hub; and
at least one magnetosensitive device located in said sensor cavity;
a rotor comprising:
a rotor body having a socket formed therein; and
at least one pair of magnets having mutually opposed poles proximal to said socket; and
a securement feature comprising:
a bushing located at said socket;
said rotor body having an end face;
said hub having an end portion protruding with respect to said end face, said end portion having a slot formed therein;
a washer on said hub located between said slot and said end face; and
a clip trapped in said slot in interfering relationship with said end face by abutment with said washer;
wherein said rotor is rotatable with respect to said stator, and wherein said securement feature maintains said rotor body axially affixed with respect to said stator body; and
wherein said at least one pair of magnets and said at least one magnetosensitive device are aligned in a plane transverse to a rotation axis of the rotor relative to the stator.

12. The rotary position sensor of claim 11, further comprising a seal between said rotor body and said stator body, wherein said rotor is sealingly rotatable with respect to said stator.

13. The rotary position sensor of claim 12, further comprising a mechanical linkage connected to said rotor body, said mechanical linkage comprising:
a ball connected with said rotor body;
a socket pivotally trapped on said ball; and
a rigid link connected to said socket.

14. The rotary position sensor of claim 13, wherein said stator and rotor bodies have mutually formed therein a spring cavity; said sensor further comprising a spring located in said spring cavity and connected with said rotor and stator bodies.
